(19) United States
(12) Patent Application Publication
(10) Pub. No.: US 2007/0151917 A1
(43) Pub. Date: Jul. 5, 2007

(54) Filtering device

(76) Inventor: Yu-Shan Kuo, Taichung City (TW)

Correspondence Address: PAI PATENT & TRADEMARK LAW FIRM, 1001 FOURTH AVENUE, SUITE 3200, SEATTLE, WA, 98154, US

(21) Appl. No.: 11/325,769

(22) Filed: Jan. 5, 2006

(51) Int. Cl. B01D 29/00

(52) U.S. Cl. 210/335; 210/344; 210/437

(57) ABSTRACT

A filtering device includes: a plurality of positioning trays stacked one above the other and disposed around the fluid-collecting tube; a plurality of membranes alternating with the positioning trays and disposed around the fluid-collecting tube; an upper flange connected to a topmost one of the trays and disposed around the fluid-collecting tube; and a lower flange connected to a bottommost one of the trays and disposed around the fluid-collecting tube. The upper and lower flanges of each of the filtering units are respectively and detachably coupled to an adjacent pair of the lower and upper flanges of an adjacent pair of the filtering units.

### BACKGROUND OF THE INVENTION

1. Field of the Invention

The invention relates to a filtering device, more particularly to a filtering device including a plurality of filtering units stacked one above the other and coupled together.

2. Description of the Related Art

Conventional filtering devices normally include a plurality of framed membranes that are assembled together. The fluid to be filtered enters one end of the assembled framed membranes, and is discharged from an opposite end of the assembled framed membranes. The conventional filtering devices are disadvantageous in that when there is a leakage, the entire assembled framed membranes are required to be disassembled, which is relatively laborious and time consuming.

### SUMMARY OF THE INVENTION

Therefore, the object of the present invention is to provide a filtering device that is capable of overcoming the aforesaid drawback associated with the prior art.

Accordingly, a filtering device of this invention comprises: a fluid-collecting tube defining a fluid channel therein and formed with a plurality of apertures that are in fluid communication with the fluid channel; and a plurality of filtering units stacked one above the other and coupled together. Each of the filtering units includes: a plurality of positioning trays stacked one above the other and disposed around the fluid-collecting tube; a plurality of membranes alternating with the positioning trays and disposed around the fluid-collecting tube; an upper flange connected to a topmost one of the trays and disposed around the fluid-collecting tube; and a lower flange connected to a bottommost one of the trays and disposed around the fluid-collecting tube. The upper and lower flanges of each of the filtering units are respectively and detachably coupled to an adjacent pair of the lower and upper flanges of an adjacent pair of the filtering units.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded schematic view of the preferred embodiment of a filtering device according to the present invention;

FIG. 2 is fragmentary sectional view of the preferred embodiment;

FIG. 3 is a partly exploded perspective view of a filtering unit of the filtering device of the preferred embodiment;

FIG. 4 is a schematic top view to illustrate the configuration of a filtering apparatus having a plurality of the filtering devices of the preferred embodiment mounted in a container; and

FIG. 5 is a fragmentary partly sectional view of the filtering apparatus.

### DETAILED DESCRIPTION OF THE PREFERRED EMBODIMENT

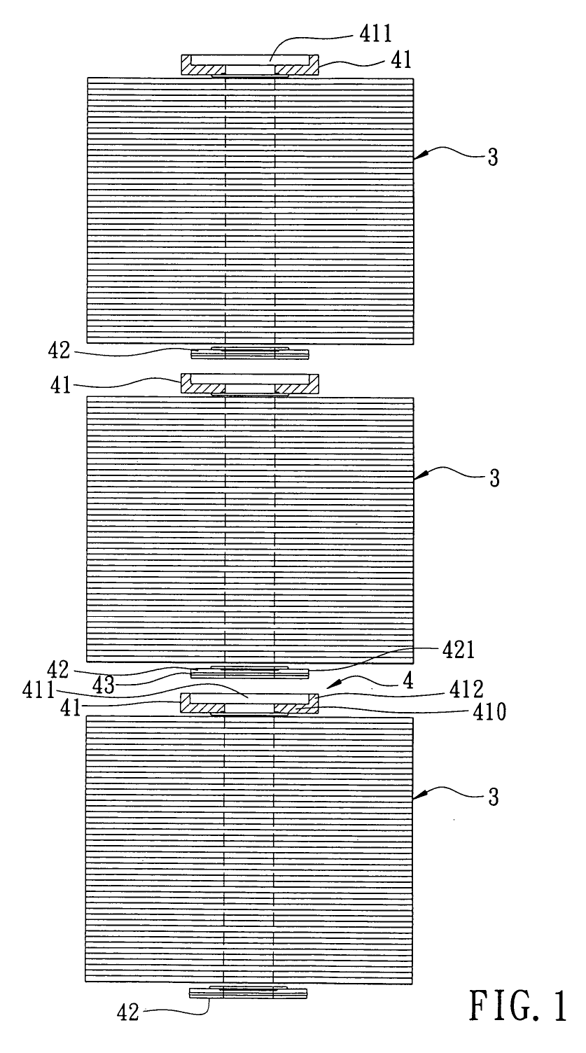

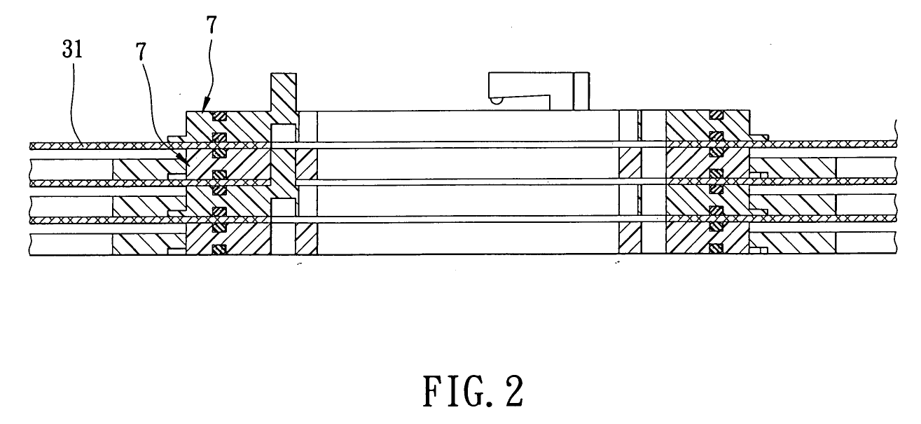

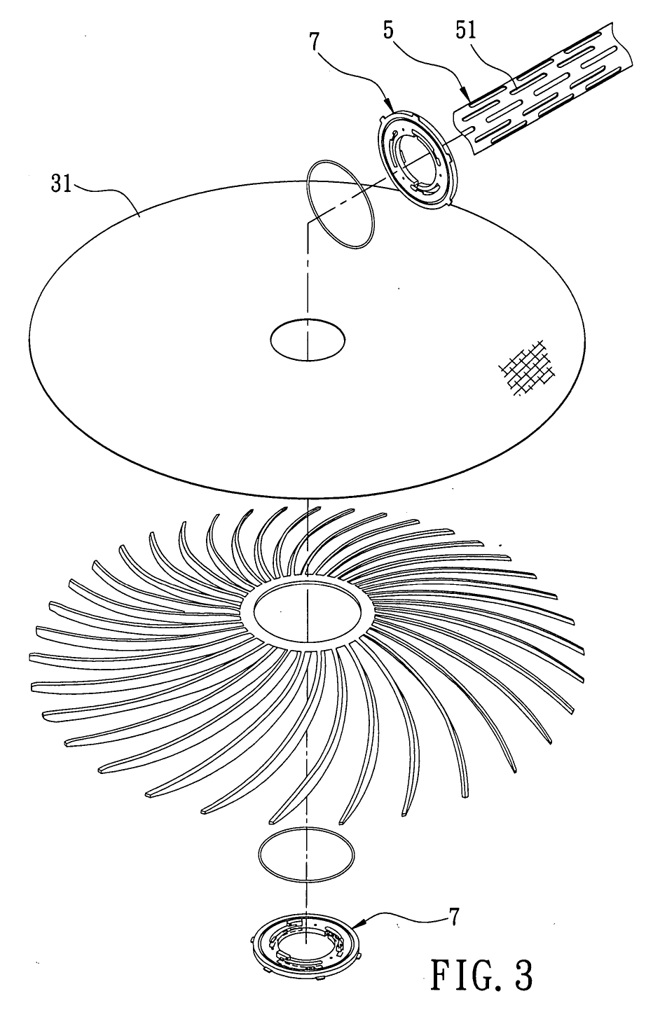

Referring to FIGS. 1 to 3, the preferred embodiment of a filtering device according to the present invention is shown to include a fluid-collecting tube 5 defining a fluid channel 50 therein and formed with a plurality of apertures 51 that are in fluid communication with the fluid channel 50, and a plurality of filtering units 3 stacked one above the other and coupled together. Each of the filtering units 3 includes: a plurality of positioning trays 7 stacked one above the other and disposed around the fluid-collecting tube 5; a plurality of membranes 31 alternating with the positioning trays 7 and disposed around the fluid-collecting tube 5; an upper flange 41 connected to a topmost one of the trays 7 and disposed around the fluid-collecting tube 5; and a lower flange 42 connected to a bottommost one of the trays 7 and disposed around the fluid-collecting tube 5.

The upper and lower flanges 41, 42 of each of the filtering units 3 are respectively and detachably coupled to an adjacent pair of the lower and upper flanges 42, 41 of an adjacent pair of the filtering units 3, thereby forming the filtering device.

In this embodiment, the lower flange 42 of each of the filtering units 3 includes an annular part 421. The upper flange 41 of each of the filtering units 3 includes an annular base part 410 and a peripheral part 412 extending from the base part 410 and cooperating with the base part 410 to define a recess 411 therebetween. The annular part 421 of the lower flange 42 of each of the filtering units 3 is fitted into the recess 411 in the upper flange 41 of the adjacent one of the filtering units 3. Each of the lower flanges 42 further includes a sealing ring 43 sleeved on the annular part 421 and in sealing contact with the engaged pair of the upper and lower flanges 41, 42 so as to provide a sealing effect to prevent the fluid from entering into the fluid-collecting tube 5 therethrough.

The filtering units 3 thus assembled are mounted in a column (not shown) that has a fluid inlet and a fluid outlet connected to the fluid-collecting tube 5 for discharging of the filtrate.

In use, a solid-containing fluid to be treated enters from the fluid inlet of the column, and is filtered through the membranes 31. The filtrate is collected in the fluid-collecting tube 5, and is discharged from the fluid outlet of the column. During the filtering operation, the solid-containing fluid not only penetrates through the membranes 31 in the normal direction normal to the membranes 31, but also penetrates through each membrane 31 in radial directions relative to the fluid-collecting tube 5 and then flows into the fluid-collecting tube 5.

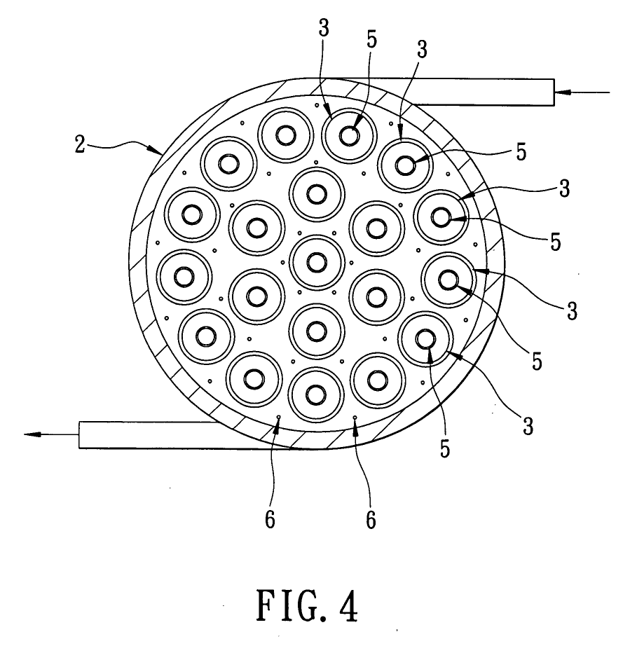

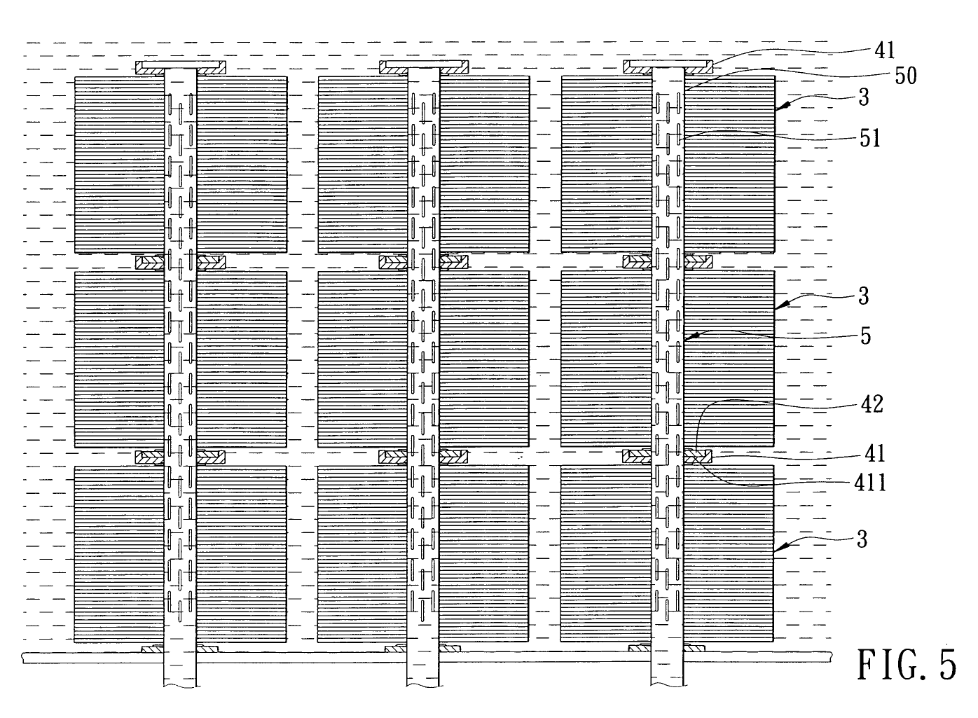

FIGS. 4 and 5 illustrate the structure of a filtering apparatus that includes a plurality of the filtering devices of this invention mounted in a large column 2 of a water treatment system. A plurality of spraying tubes 6 are mounted in the column 2, and are disposed among the filtering devices for washing the membranes 31 after a period of use.

With the inclusion of the upper and lower flanges 41, 42 in the filtering device of this invention, the filtering units 3 can be detachably coupled together, which is advantageous in that whenever there is a leakage, only the leaking filtering unit 3 is required to be detached from the filtering device for replacement or repairing, thereby mitigating the aforesaid drawback associated with the prior art.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A filtering device comprising:
a fluid-collecting tube defining a fluid channel therein and formed with a plurality of apertures that are in fluid communication with said fluid channel; and
a plurality of filtering units stacked one above the other and coupled together, each of said filtering units including
a plurality of positioning trays stacked one above the other and disposed around said fluid-collecting tube,
a plurality of membranes alternating with said positioning trays and disposed around said fluid-collecting tube,
an upper flange connected to a topmost one of said trays and disposed around said fluid-collecting tube, and
a lower flange connected to a bottommost one of said trays and disposed around said fluid-collecting tube;
wherein said upper and lower flanges of each of said filtering units are respectively and detachably coupled to an adjacent pair of said lower and upper flanges of an adjacent pair of said filtering units.

2. The filtering device as claimed in claim 1, wherein said lower flange of each of said filtering units includes an annular part, said upper flange of each of said filtering units including an annular base part and a peripheral part extending from said base part and cooperating with said base part to define a recess therebetween, said annular part of said lower flange of each of said filtering units being fitted into said recess in said upper flange of the adjacent one of said filtering units.
